(19) United States
(12) Patent Application Publication
(10) Pub. No.: US 2012/0266358 A1
(43) Pub. Date: Oct. 25, 2012

(54) HAND WEARABLE CONTROL APPARATUS

(75) Inventor: Paul Anthony Yuen, New Territories (HK)

(73) Assignee: DAYTON TECHNOLOGIES LIMITED, New Territories (HK)

(21) Appl. No.: 13/520,900

(22) PCT Filed: Jan. 10, 2011
(86) PCT No.: PCT/IB11/50082

§ 371 Date: Jul. 6, 2012

(30) Foreign Application Priority Data
Jan. 8, 2010 (HK) 10100227.3

(51) Int. Cl. A41D 19/00; A63F 13/06

(52) U.S. Cl. 2/162; 463/37

(57) ABSTRACT

A hand wearable control apparatus comprises a hand wear portion, a finger attachment portion extending from the hand wear portion and adapted for wearing on a first finger, and at least one actuation sensor formed on the finger attachment portion. The actuation sensor is disposed for operation by a second finger on the hand wearing the hand wear portion. The hand wearable control apparatus facilitates flexible control of electronic devices even when a user is doing sports or other activities. Such a hand wear apparatus also provides a user with benefits of maintaining control on a moving vehicle (such as a moving bicycle) with both hands while controlling a performance or information apparatus such as a performance monitor or a GPS.

### FIELD OF THE INVENTION

The present invention relates to hand wearable control apparatus, and more particularly to sports hand wear control apparatus.

### BACKGROUND OF INVENTION

With rapid advancements in computer and telecommunications technology, especially mobile telecommunications and positioning technologies, coupled with substantial cost reductions in technology applications, mobile telecommunications devices such as mobile GPS devices, mobile sports computers with telecommunications facilities or mobile devices with performance and/or physiological parameter monitoring capabilities are widely used in sports performance monitoring.

For many sports applications, the performance monitoring apparatus are typically mounted on fast moving sports equipment, such as a bicycle, a motorcycle, or paraglide, etc, which requires hand control. Frequently, a user is required to move his hand away from the equipment in order to control the monitoring apparatus, for example, to change monitoring mode, or to cause display or change display mode. Such movements are undesirable as sport performance, personal stability or equipment stability might be adversely affected.

Therefore, it is desirable if an improved apparatus is provided to mitigate control shortcomings of conventional sports or performance monitoring apparatus.

### SUMMARY OF INVENTION

According to the present invention, there is provided a hand wearable control apparatus comprising a hand wear portion, a finger attachment portion extending from the hand wear portion and adapted for wearing on a first finger, and at least one actuation sensor formed on the finger attachment portion, wherein the actuation sensor is disposed for operation by a second finger on the hand wearing the hand wear portion. The hand wearable control apparatus facilitates flexible control of electronic devices even when a user is doing sports or other activities. Such a hand wear apparatus also provides a user with benefits of maintaining control on a moving vehicle (such as a moving bicycle) with both hands while controlling a performance or information apparatus such as a performance monitor or a GPS.

The finger attachment portion defines a finger attachment bore for receiving the index or middle finger of a user, the finger received within the bore being arranged to provide an operation reactionary force for operation of the actuation sensor. As the first finger is behind the actuation sensor during operation, a user will be able to feel the application of actuation force and this promotes better user controllability.

The at least one actuation sensor may disposed on a side of the finger attachment portion which faces the thumb of a user during use such that the at least one actuation sensor is operable by the thumb of the user. The at least one actuation sensor may disposed on a side of the finger attachment portion which faces away from the thumb of a user during use such that the at least one actuation sensor is operable by a non-thumb finger adjacent the first finger.

Such an arrangement permits an electronic apparatus to be controllable by using a single finger while the user is controlling a moving vehicle. Also, this facilitates both thumbed and non-thumbed operation for enhanced flexibility of control and user convenience.

The hand wear portion may include a thumb aperture through which the thumb of a user protrudes to access and operate the actuation sensor. This thumb aperture provides easy and flexible thumb access to control an actuation sensor or switch. The thumb aperture is beneficial because it permits a user to user the thumb to control a relatively small actuation switch with high operational sensitivity.

The hand wear portion may comprise a wrist wrap portion for wrap-around wearing on the wrist of a user, and the thumb aperture is intermediate the wrist wrap portion and the finger attachment portion. The wrist wrap portion provides a positioning support for the apparatus. Such an aperture configuration also provides unhindered or enhanced flexibility for the thumb of a user for effective control of the actuation sensors.

The hand wear portion may comprise a second aperture, the second aperture being intermediate the wrist wrap portion and the finger attachment portion, and being separated from the thumb aperture by the finger attachment portion. This second, non-thumb fingers, aperture permits protrusion of the non-thumb fingers from the hand wear portion during use to enhance flexibility of user, and also provides flexibility to other fingers of a user for more flexible and sensitive control.

The hand wear portion may be arranged to permit exposure of the palm and all fingers except the first finger when worn. This permits a user to have a direct grip of an article, such as a control bar or hand grip, for better control. The palm aperture provides good hand grip for a user when wearing the control apparatus. In addition, the palm aperture also permits the palm of a user to expose, thereby providing palm contacts for taking ECG signal measurements.

The wrist wrap portion may comprise a flexible strap portion for wrapping around the wrist of a user in use, and fastening means for releasable fastening of the wrist wrap portion on the wrist of a user.

The finger attachment portion comprises a flexible strap portion for wrapping around the first finger of a user during use, and a fastening means for releasable fastening of the finger attachment portion onto the first finger of the user.

These facilitate quick and easy wearing and removal.

For example, the fastening means may comprise Velcro® fastening parts.

The finger attachment portion and the hand wear portion may be detachably attached.

According to another aspect of the invention, there is provided a sports hand wear comprising a hand wear control apparatus of the present invention, wherein the hand wear portion is adapted to facilitate effective hand grip of a user on sports equipment during use.

### BRIEF DESCRIPTION OF DRAWINGS

Embodiments of the invention will be explained by way of non-limiting example with reference to the accompanying drawings, in which:—

FIG. 1 shows a plan view of a hand wear apparatus illustration an embodiment of the present invention,

FIG. 2 is a rear view of the hand wear apparatus of FIG. 2,

FIG. 3 is a perspective view depicting the apparatus of FIGS. 1 & 2 in use, and

FIG. 4 shows the rear view of the apparatus in use.

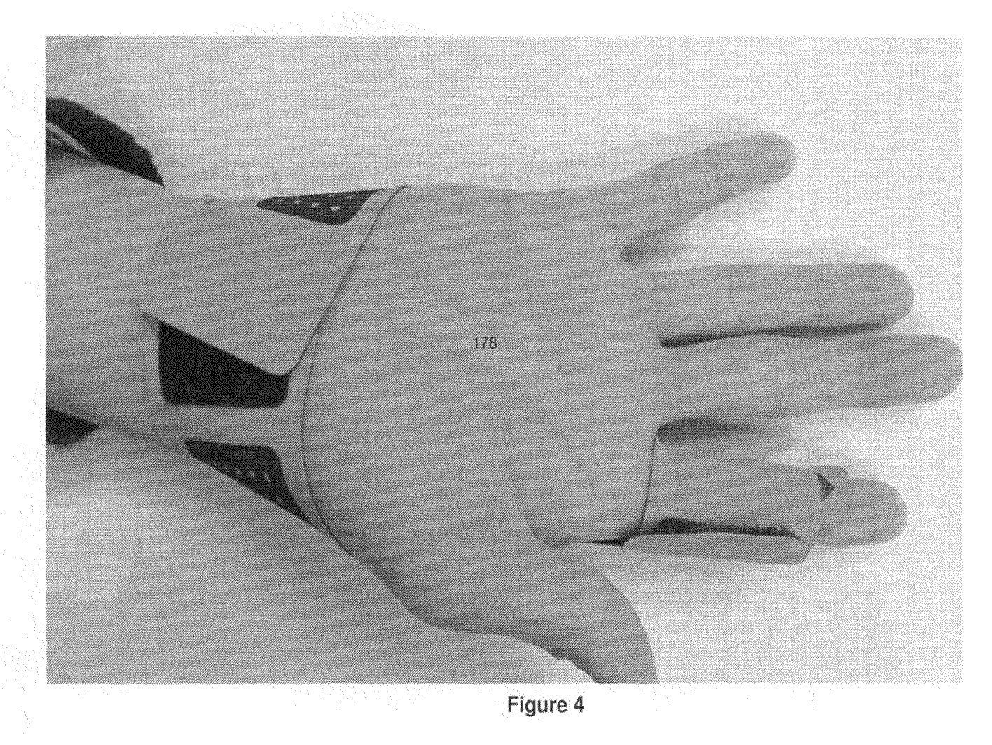

### DETAILED DESCRIPTION OF EMBODIMENTS

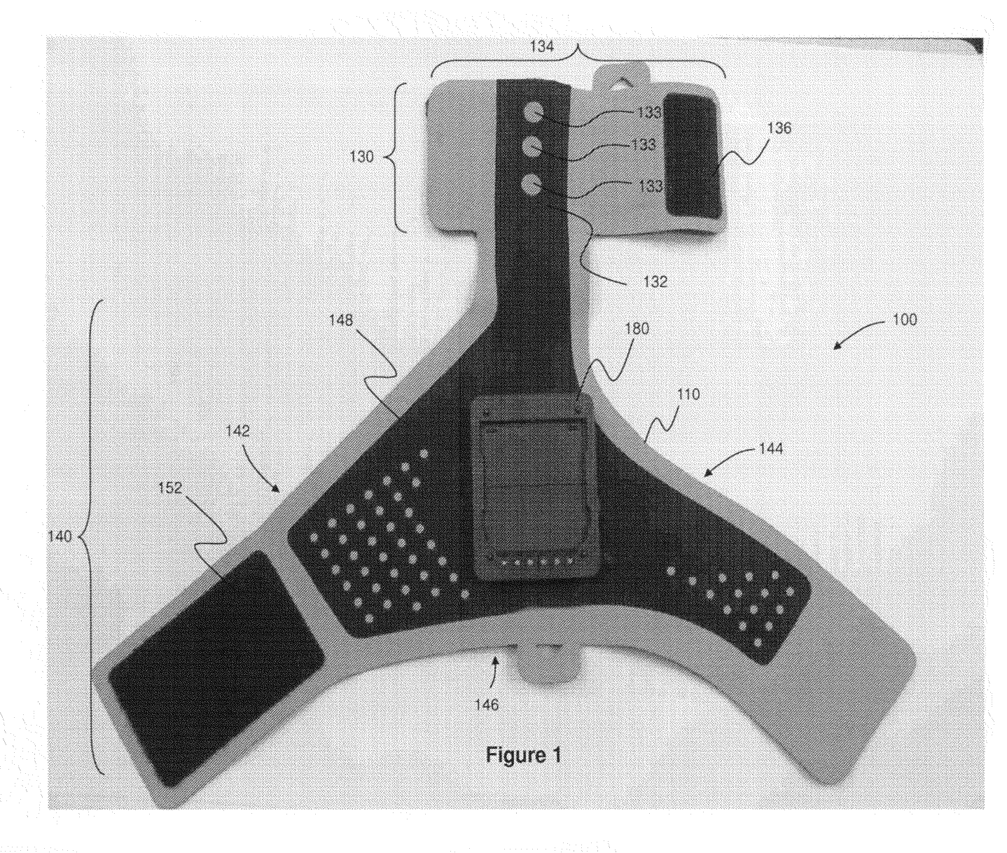

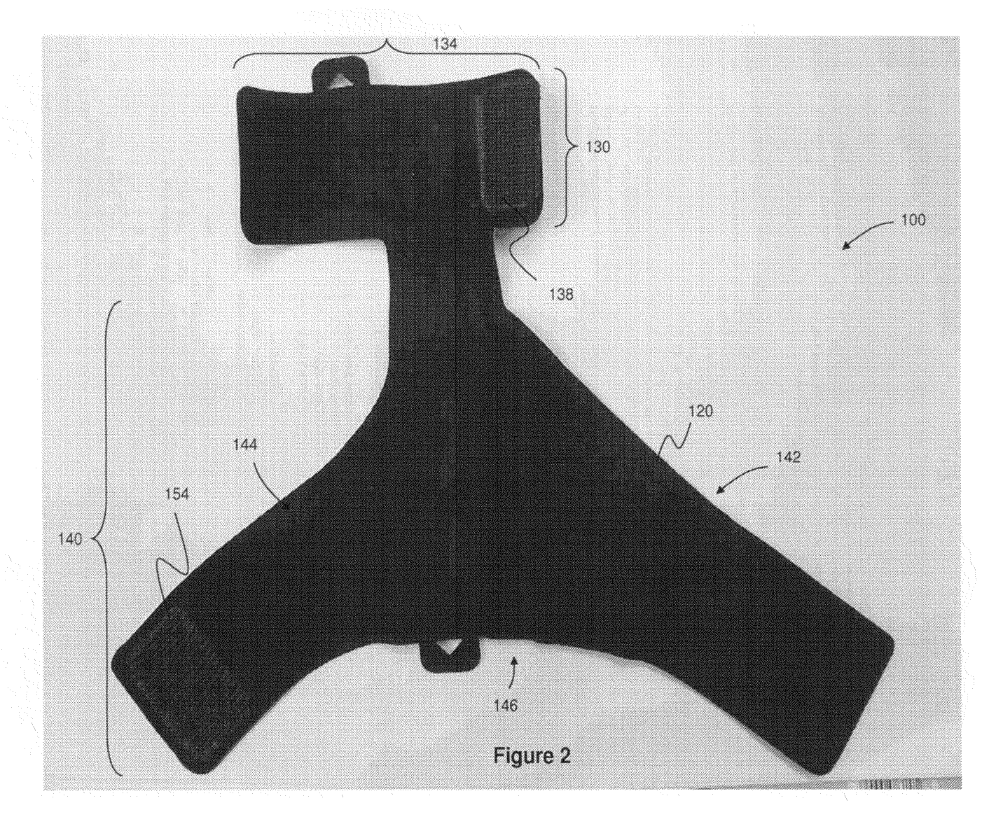

Referring to FIGS. 1 to 3, the hand wear apparatus 100 comprises an upper layer 110 and a lower layer 120 which are glued together so that actuation sensors 133 and connecting conductors are embedded between the two layers to be explained in more detail below. Each of the layers is made of soft, flexible and breathable fabric materials, such as polyamide, a mixture of polyamide and an elastomer, or polyester.

The hand wear control apparatus comprises a hand mount having two main regions, namely, a finger attachment portion 130 and a main body comprising a hand wear portion 140. The hand wear portion 140 is designed and adapted to be worn and stay on the back (or dorsal) of a user's hand during use and comprises a flexible wrist wrap portion 150 which is arranged to fasten the hand wear portion 140 on the wrist of the user. Velcro® or other convenient fastening means 152,154 such as magnetic clasps or fasteners is used to keep the wrist wrap portion 150 on the wrist of a user. The finger attachment portion 130 comprises an elongate portion 132 on which a plurality of actuation sensors 133 or actuation switches is disposed. The actuation sensors 133 are disposed on the elongate portion 132 of the finger attachment portion 130, preferably along its length, and are arranged such that they are readily accessible by the thumb of a user when the control apparatus is worn.

The elongate portion 132 of the finger attachment portion 130 is adapted for mounting on the index or middle finger of a user and its length is designed so that it covers the first node to permit substantially free movements for the remaining sections of the finger. A fastening strap 136, 138 with fastening means, such as Velcro arrangements or magnetic clasps for convenience, and extending laterally from the elongate portion 132 is provided so that the elongate portion 132 can be maintained on the finger during use when the laterally extending strap portion 134 is wrapped around the finger. The laterally extending strap 134 on the elongate portion 132 has a length which extends to the base of the finger so that the finger could move freely with respect to the main body or hand wear portion of the control apparatus. The elongate portion 132 is an extension, preferably an integral extension, of the hand wear portion such that a finger wearing the finger attachment portion 130 can pivotally move with respect to the main body portion.

Embedded signal conductors connecting the actuation sensors 133 and respective terminations on the dorsal portion of the hand wear portion run along the entire length of the elongate portion and terminate at the terminations. The signal conductors are provided to facilitate control signal communications between the actuation sensor 133 and an electronic apparatus to be mounted on the hand wear portion.

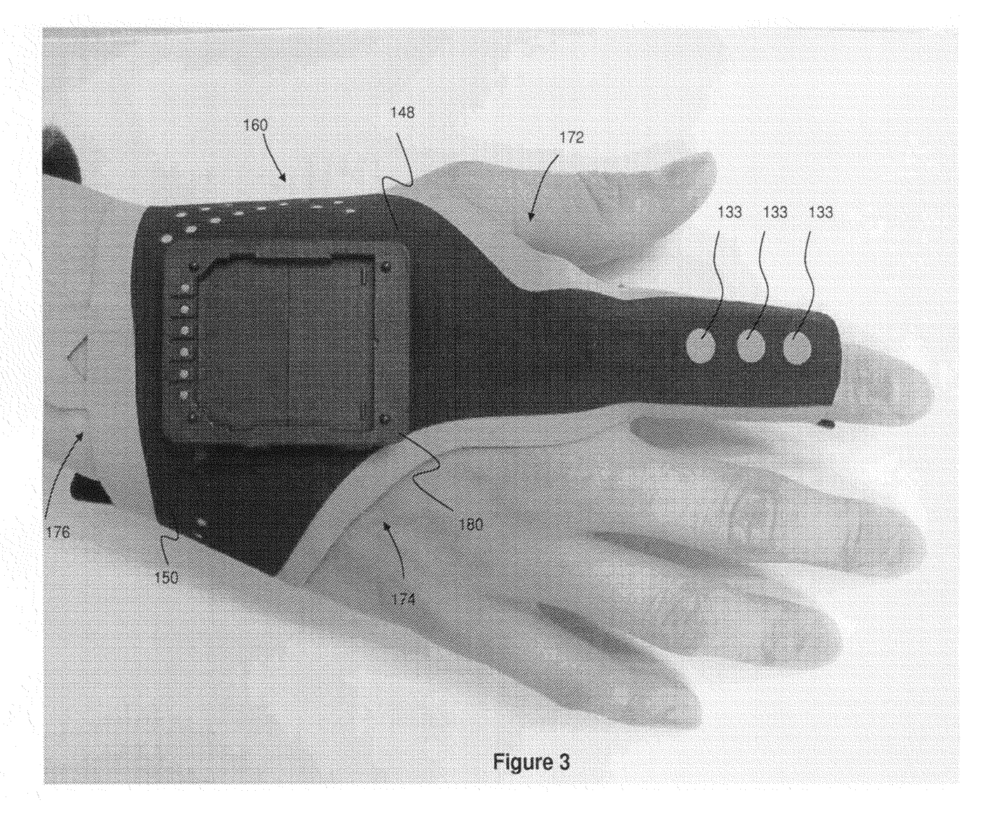

The hand wear portion 140 comprises a first side 142 and a second side 144 which are configured to follow predetermined curvatures for smooth and comfortable wear and finger movements. The first side extends from the base of one side of the elongate portion 132 and terminates at a first fastening part 152 of the wrist wrap portion 150. The first side contour of curvature is configured so that it extends from the base of the wearing finger and runs substantially diagonally along the edge of the dorsal portion 160 adjacent the base of the thumb until reaching the wrist portion of a user, as shown in FIG. 3. This contour or curvature substantially follows the natural contour of the dorsal portion 160 of the hand between the base of the wearing finger and the wrist portion. Such a configuration, or diagonal configuration, defines a first aperture 172 though which the thumb can protrude to smoothly and comfortably control the actuation sensors 133 or other devices where available.

The second side 144 extends from the base of one side of the elongate portion 132 and terminates at a second fastening part 154 of the wrist wrap portion 150. The second side contour of curvature is configured so that it extends from the base of the wearing finger and runs substantially diagonally along the edge of the dorsal portion 160 adjacent the base of the little finger until reaching the wrist portion 150 of a user, as shown in FIG. 3. This contour or curvature substantially follows the natural contour of the dorsal portion 160 of the hand between the base of the wearing finger and the wrist portion 150. Such a configuration, or diagonal configuration, defines a second aperture 174 though which the fingers between the wearing finger and the second fastening part 154 (i.e., fingers other than the thumb and the wearing finger) can protrude to smoothly and comfortably control sports equipment.

Referring to FIG. 1, the hand wear portion 140 of the apparatus comprises a main patch portion 148 which is bound by the first side 142, the second side 144 and a wrist side 146. The main patch portion 148 includes a generally triangular portion having a wide base at the wrist end which tapers towards the finger attachment portion, at which the first and second sides converge. The first side 144, the second side 146 and the wrist side 148 respectively defines a first aperture 172, a second aperture 174, and a third aperture 176, in which the first aperture 172 is provided for thumb movements, the second aperture 174 is for movements of other fingers, and the third aperture 176 is for wrist reception. Such a triangular configuration also defines a fourth aperture 178 which exposes the palm of a user during use. Exposure of a user's palm during facilitates a better hand grip and/or permitting ECG measurements, and is therefore particularly advantageous. As depicted in FIG. 1, the hand wear control apparatus in its non-use state could be fully spread and lie flat on a plane surface.

A receptacle 180 on which an electronic device such as a GPS device, bicycle computer, mobile phone, smart phone, could be mounted is secured to the main patch portion 148. The receptacle 180 comprises electrical contacts, for example exposed contacts, for connection with the electronic device such that control signals could be communicated between the actuation sensor 133 and the electronic device. The signal conductors connected to the actuation sensors 133 are terminated at the receptacle 180. The receptacle also includes a mechanical mounting arrangement in order to detachable securing the electronic device onto the receptacle 180.

When in use, and as shown in FIGS. 3 & 4, the finger attachment portion is mounted on the index or middle finger of either the left or right hands of a user, such ambidexterity provide useful choice and convenience for a user. After the finger attachment portion has been duly attached, the wrist wrap portion is fastened on the wrist of a user and a user can control the electronic apparatus attached to the hand wear control apparatus to perform various control and monitoring functions. By thumb operating the actuation sensors 133, a user could easily control the electronic device and view the instantaneous information displays while both hands maintain control of a moving sports apparatus.

While the embodiment comprises two flexible layers glued together, it will be understood that the hand wear apparatus could be formed by sewing, mounding or other appropriate techniques. Also, while the embodiment described above includes a receptacle 180 mounted on the main patch portion 148, it will be appreciated that the receptacle 180 could be mounted on the wrist side 146 or other appropriate locations. Further, while the finger attachment portion 130 comprises a flexible strap 136,138 which could be releasably fastened, it will be appreciated by persons skilled in the art that the finger attachment portion could be in a permanent form for finger insertion. Naturally, other variations and modifications would be apparent to persons skilled in the art without loss of generality. For example, the hand wear could be formed into a conventions glove shape, including glove with finger tips expose.

In another embodiment, the finger attachment portion together with the actuation sensors and the electronic device or the receptacle are formed as a single finger attachment unit, which is detachable from the wrist wear portion. In this embodiment, the combined finger attachment unit is attachable to the wrist portion by fastener means such as Velcro®, snap fasteners or a combination thereof. For example, the receptacle or the electronic device may be attached to the wrist portion during use and to be detached when not in use. As an option, the finger attachment portion may also be attached to the main hand wear portion with an additional fastening means. As the finger attachment portion and the hand wear portion are detachably attached, either portions could be detached, replaced, repaired, cleaned or updated when desired.

While the present invention has been explained with reference to the embodiments above, it should be appreciated that the embodiments are only described to illustrate the invention and are not meant for restricting the scope of invention. For example while a control apparatus comprising a single finger attachment portion has been illustrated as an example, it should be appreciated that a control apparatus of the present invention may comprise more than one finger attachment portions and each finger attachment portion may comprise more than one actuation sensor without loss of generality.

### TABLE OF NUMERALS

| | | |
|---|---|---|
| 100 | | Hand wear apparatus |
| 110 | | Upper layer |
| 120 | | Lower layer |
| 130 | | Finger attachment portion |
| | 132 | Elongate portion |
| | 133 | Actuation sensor |
| | 134 | Laterally extending strap |
| | 136 | Flexible strap |
| | 138 | Flexible strap |
| 140 | | Hand wear portion |
| | 142 | First side |
| | 144 | Second side |
| | 146 | Wrist side |
| | 148 | Main patch portion |
| 150 | | Wrist wrap portion |
| | 152 | First fastening part |
| | 154 | Second fastening part |
| 160 | | Dorsal portion |
| | 172 | First aperture |
| | 174 | Second aperture |
| | 176 | Third aperture |
| | 178 | Fourth aperture |
| 180 | | Receptacle |

1. A hand wearable control apparatus comprising a hand wear portion, a finger attachment portion extending from the hand wear portion and adapted for wearing on a first finger, and at least one actuation sensor formed on the finger attachment portion, wherein the actuation sensor is disposed for operation by a second finger on the hand wearing the hand wear portion.

2-25. (canceled)

26. A control apparatus according to claim 1, wherein the finger attachment portion defines a finger attachment bore for receiving the index or middle finger of a user, the finger received within the bore being arranged to provide an operation reactionary force for operation of the actuation sensor, and wherein the at least one actuation sensor is disposed on a side of the finger attachment portion which faces the thumb of a user during use such that the at least one actuation sensor is operable by the thumb of the user.

27. A control apparatus according to claim 1, wherein the at least one actuation sensor is disposed on a side of the finger attachment portion which faces away from the thumb of a user during use such that the at least one actuation sensor is operable by a non-thumb finger adjacent the first finger.

28. A control apparatus according to claim 1, wherein the hand wear portion includes a thumb aperture through which the thumb of a user protrudes to access and operate the actuation sensor, and wherein the hand wear portion comprises a wrist wrap portion for wrap-around wearing on the wrist of a user, and the thumb aperture is intermediate the wrist wrap portion and the finger attachment portion.

29. A control apparatus according to claim 28, wherein the hand wear portion comprises a second aperture, the second aperture being intermediate the wrist wrap portion and the finger attachment portion, and being separated from the thumb aperture by the finger attachment portion and wherein the hand wear portion is arranged to permit exposure of the palm and all fingers except the first finger when worn.

30. A control apparatus according to claim 1, wherein the wrist wrap portion comprises a flexible strap portion for wrapping around the wrist of a user in use, and fastening means for releasable fastening of the wrist wrap portion on the wrist of a user, and wherein the finger attachment portion is an integral extension of the hand wear portion.

31. A control apparatus according to claim 1, wherein the finger attachment portion comprises a flexible strap portion for wrapping around the first finger of a user during use, and a fastening means for releasable fastening of the finger attachment portion onto the first finger of the user.

32. A control apparatus according to claim 1, wherein the hand wear portion and the finger attachment portion are integrally formed of a soft, flexible and breathable fabric such as polyamide.

33. A control apparatus according to claim 1, wherein the actuation sensor comprises a resiliently biased contact switch which returns to a non-actuation state when finger pressure is removed.

34. A control apparatus according to claim 1, wherein a plurality of actuation sensors is disposed on the finger attachment portion.

35. A control apparatus according claim 1, wherein the at least one actuation sensor is for operation of an electronic device on the hand wear portion via at least one signal conductor, the at least one signal conductor being embedded in the hand wear.

36. A control apparatus according to claim 35, wherein the signal conductor extends from the finger attachment portion and terminates at the wrist wrap portion, the signal conductor being embedded between two layers of flexible and breathable fabric.

37. A control apparatus according to claim 36, wherein a device receptacle with bare electrical contacts for making electrical connection with the electronic device is mounted on the hand wear portion at a location corresponding to the back of the hand, the device being adapted for detachable latched reception of the electronic device.

38. A control apparatus according to according to claim 37, wherein the electronic device is a telecommunications device controllable by the actuation sensor, the telecommunications device including a GPS apparatus, a mobile phone, a smart phone, a bicycle computer.

39. A control apparatus according to according to claim 37, wherein the electronic device is portable and is adapted for connection as a module to other hosting devices.

40. A control apparatus according to claim 1, wherein the hand wear portion and the finger attachment portions are adapted for ambidextrous applications.

41. A control apparatus according to claim 1, wherein the apparatus is spreadable on a flat surface like a piece of soft skin when not in use.

42. A control apparatus according to claim 1, wherein the finger attachment portion and the hand wear portion are detachably attached.

43. A sports hand wear comprising a hand wear control apparatus, wherein the hand wear control apparatus comprises a hand wear portion, a finger attachment portion extending from the hand wear portion and adapted for wearing on a first finger, and at least one actuation sensor formed on the finger attachment portion, wherein the actuation sensor is disposed for operation by a second finger on the hand wearing the hand wear portion, wherein the hand wear portion is adapted to facilitate effective hand grip of a user on sports equipment during use.

44. A sports hand wear according to claim 43, wherein the sports hand wear is adapted for cycling applications.
